(19) United States
(12) Patent Application Publication
(10) Pub. No.: US 2026/0184572 A1
(43) Pub. Date: Jul. 2, 2026

(54) A METHOD FOR THE PRODUCTION OF EDGE FUNCTIONALISED GRAPHENE

(71) Applicant: SICONA BATTERY TECHNOLOGIES PTY LTD, North Wollongong, New South Wales (AU)

(72) Inventors: Gregory Michael RYDER, North Wollongong, New South Wales (AU); Gordon George WALLACE, North Wollongong, New South Wales (AU); David Leslie OFFICER, North Wollongong, New South Wales (AU); Jamie SMYTH, North Wollongong, New South Wales (AU)

(73) Assignee: SICONA BATTERY TECHNOLOGIES PTY LTD, North Wollongong, New South Wales (AU)

(21) Appl. No.: 19/129,565

(22) PCT Filed: Dec. 15, 2023
(86) PCT No.: PCT/AU2023/051309

§ 371 Date: May 13, 2025

(30) Foreign Application Priority Data
Dec. 19, 2022 (AU) 2022903890

(51) Int. Cl. C01B 32/184; C01B 32/196; H01M 4/1393; H01M 4/36; H01M 4/583; H01M 4/62

(52) U.S. Cl. CPC C01B 32/184; C01B 32/196; H01M 4/1393; H01M 4/366; H01M 4/583; H01M 4/623; C01B 2204/22; C01P 2002/82; C01P 2004/03; C01P 2004/24

(57) ABSTRACT

The present disclosure provides a new method of making dispersible graphene platelets. The structure of the graphene platelet comprises a base layer of graphene on which at least one discontinuous layer of graphene is stacked, with each layer of graphene above the base layer having a smaller surface area than the layer it is stacked upon. The edges of the base layer and the discontinuous layers stacked upon it are all at least partially functionalised, providing a structure with graphene-like properties owing to the base layer and relatively high dispersibility owing to the increased amount of functionalised groups on each platelet. The inventive method employs Fenton chemistry such that iron(II) chloride/hydrogen peroxide is used as an oxidant, which represents an improvement on the methods of the prior art. The dispersible graphene platelets have, amongst other properties, favourable heat transfer characteristics and find potential uses in cooling data centres, HVAC and the like.

### CROSS-REFERENCE TO RELATED APPLICATIONS

This application is a U.S. National Phase of PCT Application No. PCT/AU2023/051309, filed on Dec. 15, 2023, which claims the benefit of Australian Provisional Patent Application No. 2022903890, filed Dec. 19, 2022, the entireties of which are incorporated herein by reference.

### FIELD OF THE INVENTION

The present disclosure relates to an edge functionalised graphene platelet structure and to a novel method of producing same employing iron(II) chloride/hydrogen peroxide as an oxidant. The platelets may be used for a number of applications, for example in the production of electrodes or composite materials, or use as a thermal fluid for cooling server farms and the like.

Although the present invention will be described hereinafter with reference to its preferred embodiment, it will be appreciated by those of skill in the art that the spirit and scope of the invention may be embodied in many other forms.

### BACKGROUND OF THE INVENTION

Any discussion of the prior art throughout the specification should in no way be considered as an admission that such prior art is widely known or forms part of common general knowledge in the field.

Graphene, a carbon film one atomic layer thick, has a number of desirable properties such as high thermal and electrical conductivity as well as high mechanical strength. Accordingly, graphene is a promising material for a wide range of applications such as energy storage, biological sensing, and filtration, as well as improved electrical and medical devices. Currently though, use of graphene in these applications is limited by the difficulty in producing and storing large quantities of graphene or graphene derivatives such as nanoplatelets or nanoribbons for industrial scale manufacture while maintaining the desired properties of graphene. The term graphene is commonly accepted to refer to a particular class of carbon films (and associated materials) between one and ten atomic layers thick. It will thus be understood that throughout this specification, that graphene refers to carbon films of up to ten atomic layers. Graphene platelets with more than ten atomic layers are typically referred to as graphite.

Since graphene was first isolated by mechanical cleavage through the ‘scotch tape’ method where adhesive tape was used to strip layers of graphene off bulk graphite, numerous processing routes such as chemical vapour deposition and ball milling have been investigated with the aim of providing an efficient method to produce industrial scale quantities of graphene, but currently, few have proved viable.

The Hummers' method, developed in the 1950s to produce graphite oxide, has been modified to enable the production of large quantities of graphene oxide. Attempts have been made to convert graphene oxide to graphene by reduction. Currently however, graphene oxide has not been successfully reduced to graphene, such that while large quantities can be produced, they have sub-optimal properties compared to native graphene.

A means of increasing the dispersity of graphene structures is by functionalising the edges of the graphene sheets. This allows the structure to substantially retain the properties of native graphene while increasing the dispersity. These structures are often referred to as edge-functionalised graphene.

A method for producing edge functionalised graphene was described by Ding, et al., Sci. Rep. 8:5567 (2018). The Ding method relates to the challenge of the high efficiency exfoliation of graphene into single- or few-layered nanoplates. Ding reports a scalable and green method to exfoliate graphene nanoplatelets (GNPs) from natural graphite in pure water without using any chemicals or surfactants. The essence of this strategy lies in the facile liquid exfoliation route with the assistance of vapor pre-treatment for the preparation of edge hydroxylated graphene. The produced graphene consisted primarily of fewer than ten atomic layers. The graphene can be stored in the form of a water dispersion (˜0.55 g/L) or filter cake for more than six months without the risk of restacking. The method paves the way for the environmentally-friendly and cost-effective production of graphene-based materials.

Applicant's prior publication WO 2020/073081 describes a dispersible graphene platelet for forming a stable dispersion in water at concentrations up to 700 mg/mL (with the higher concentrations representing doughs or putties), the platelet including: one or two base layers of graphene; one to four discontinuous graphene layer stacked on the base layer; wherein each discontinuous layer has a smaller surface area than the base layer; wherein each base layer and each discontinuous layer is defined by a central region and an edge region; and wherein the edge regions of the base layers and the discontinuous layer are at least partially functionalised and the central regions of the base layers and the discontinuous layers are at least partially unfunctionalised.

The method involves the edge oxidation of the graphene layers in graphite using a ruthenium tetroxide catalyst, a selective oxidising agent, and subsequent physical exfoliation of the edge oxidised layers to give EFG graphene nanoplatelets. WO'081 further describes a method for producing such dispersible graphene platelets, comprising the steps of suspending graphite or graphene in a solution containing an organic nitrile (such as acetonitrile), an ester (such as ethyl acetate) and water; and reacting the solution containing suspended graphite or graphene with ruthenium tetroxide to at least partially functionalise edge regions of the graphite or graphene without modifying an inner structure of the graphite or graphene.

As taught at paragraph [0056] of WO'081, ruthenium tetroxide gives strong but selective oxidation effects, converting the outermost rings to carboxylic acids or phenols while crucially leaving the inner structure unmodified. This allows the graphene platelets to have properties akin to unmodified graphene while also having an increased dispersibility owing to the functionalised edges. Moreover, some of the RuO₄ is invariably and uncontrollably lost due to evaporative processes in the unsealed reactor. Although ruthenium tetroxide/sodium periodate is an effective oxidant, the present Inventors sought alternative oxidants that did not present the significant drawbacks of the technology disclosed in WO'081.

Although paragraphs [0074] and [0075] of WO'081 mention iron chloride, this is within the context of further functionalisation of the edge functionalised graphene, not its use as an oxidant.

Agarwal, et al., Derivatisation and interlaminar debonding of graphite-iron nanoparticle hybrid interfaces using Fenton chemistry, Phys Chem Chem Phys 2017, 19 (25), 16329-16336, described a process in which interfacial debonding of graphite lattices was effected using iron nanoparticles and Fenton's reagent. Acoustic cavitation via a sonochemical route was adapted to produce iron and iron oxide nanoparticles in the graphite matrix. The oxygenated species were introduced into the graphite lattice using a physical method, and then Fenton chemistry was utilised to generate localised hydroxyl radicals at the Fe nanoparticle-graphite interfaces for zipping and self-exfoliation of the defected graphite lattices. As will be shown below, the graphene produced via the Agarwal method has perceptibly less advantageous properties by comparison with that produced by the inventive method described herein.

Other representative prior art includes U.S. Pat. No. 9,586,825, KR 20150096975, WO 2013/040356, WO 2011/016889, CN 114040889A, BR 102013011804 and US 2017/0217775. Of these prior art documents, ruthenium tetroxide is only briefly mentioned in WO'889. However, this document teaches in paragraph [0042] that potassium permanganate is preferred as an oxidant. WO'889 also does not teach the creation of a dispersible graphene platelet with discontinuous layers with functionalised edges. Further, not one of these documents discusses the use of Fenton-like chemistry to achieve such products.

A thermal fluid is a gas or liquid that facilitates thermal conductivity by serving as an intermediary in cooling on one side of a process, transporting and storing thermal energy, and heating on another side of a process. Thermal fluids are used in countless applications and industrial processes requiring heating or cooling, typically in a closed circuit and in continuous cycles. Cooling water for instance cools an engine, while heating water in a hydronic heating system heats the radiator in a room. Water is the most common thermal fluid because of its economy, high heat capacity and favorable transport properties. However, the useful temperature range is restricted by freezing below 0° C. and boiling at elevated temperatures depending on the system pressure. Antifreeze additives can alleviate the freezing problem to some extent. However, many other thermal fluids have been developed and used in a huge variety of applications.

For higher temperatures, oil or synthetic hydrocarbon or silicone based fluids offer lower vapor pressure. Molten salts and molten metals can be used for transferring and storing heat at temperatures above 300 to 400° C. where organic fluids start to decompose. Gases such as water vapor, nitrogen, argon, helium and hydrogen have been used as thermal fluids where liquids are not suitable. For gases the pressure typically needs to be elevated to facilitate higher flow rates with low pumping power.

A server farm represents a modern day challenge for thermal fluids. A server farm is a collection of computer servers usually maintained by an organisation to supply server functionality far beyond the capability of a single machine. Server farms often consist of many thousands of computers which require a large amount of power to run and generate a large amount of heat, which also then requires a large amount of to keep the server farm cool so as to maintain efficiency. Server farmers typically mount the computers, routers, power supplies, and related electronics on 19-inch racks in a server room or data centre. Because space is at a premium, it follows that the server racks should be housed as closely as possible. However, this gives rise to significant air flow, heating and cooling issues.

While the performance of servers is improving, the power consumption of servers is also rising despite efforts in low power design of integrated circuits. For example, one of the most widely used server processors runs at up to 95 watts. Another server processor runs at between 110 and 165 watts. Processors are only part of a server, however; other parts in a server such as storage devices consume additional power and all parts contribute to the overall heat generation.

A data centre room should be maintained at acceptable temperatures and humidity for reliable operation of the servers, especially for fanless servers. The power consumption of a rack densely stacked with servers powered by modern processors may be between 7000 and 15,000 watts. As a result, server racks can produce very concentrated heat loads. The heat dissipated by the servers in the racks is exhausted to the data centre room. The heat collectively generated by densely populated racks can have an adverse effect on the performance and reliability of the equipment in the racks, since they rely on the surrounding air for cooling. Accordingly, heating, ventilation, air conditioning (HVAC) systems are often an important part of the design of an efficient data centre.

In a data centre room, server racks are typically laid out in rows with alternating cold and hot aisles between them. All servers are installed into the racks to achieve a front-to-back airflow pattern that draws conditioned air in from the cold rows, located in front of the rack, and ejects heat out through the hot rows behind the racks. A raised floor room design is commonly used to accommodate an underfloor air distribution system, where cooled air is supplied through vents in the raised floor along the cold aisles.

An important factor in efficient cooling of data centre is to manage the air flow and circulation inside a data centre. Computer Room Air Conditioners (CRAC) units supply cold air through floor tiles including vents between the racks. In addition to servers, CRAC units consume significant amounts of power as well. One CRAC unit may have up to three 5 horsepower motors and up to 150 CRAC units may be needed to cool a data centre. The CRAC units collectively consume significant amounts of power in a data centre. For example, in a data centre room with hot and cold row configuration, hot air from the hot rows is moved out of the hot row and circulated to the CRAC units. The CRAC units cool the air. Fans powered by the motors of the CRAC units supply the cooled air to an underfloor plenum defined by the raised sub-floor. The pressure created by driving the cooled air into the underfloor plenum drives the cooled air upwardly through vents in the subfloor, supplying it to the cold aisles where the server racks are facing. To achieve a sufficient air flow rate, hundreds of powerful CRAC units may be installed throughout a typical data centre room. However, since CRAC units are generally installed at the corners of the data centre room, their ability to efficiently increase air flow rate is negatively impacted. The cost of building a raised floor generally is high and the cooling efficiency generally is low due to inefficient air movement inside the data centre room. In addition, the location of the floor vents requires careful planning throughout the design and construction of the data centre to prevent short circuiting of supply air.

It is an object of the present invention to overcome or ameliorate at least one of the disadvantages of the prior art, or to provide a useful alternative.

Especially preferred forms of the present invention seek to provide an edge-functionalised graphene platelet structure which substantially retains the beneficial properties of pure graphene but is also capable of being stored in higher concentrations than existing graphene structures.

A further preferred form of the present invention relates to an EFG fabrication method using the Fenton reaction that involves iron chloride as catalyst in conjunction with hydrogen peroxide. The structure and properties of the EFG produced are substantially analogous to those of the EFG obtained previously by the process described in WO'081. The key advantages of this new Fenton method are the easy scalability of the method, the use of a considerably cheaper catalyst system, a substantially less toxic preparation method and substantially greener process given that only water is used as solvent.

A further preferred form of the present invention relates to a composition suitable for use as a thermal fluid for use in cooling, for instance, a data centre, a radiator or an air conditioner. Due to the cost and favourable thermal profile of water, it is envisaged that water should comprise the primary component of the composition.

Although the invention will be described with reference to specific examples it will be appreciated by those skilled in the art that the invention may be embodied in many other forms.

### Definitions and Nomenclature

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”, having regard to normal tolerances in the art. The examples are not intended to limit the scope of the invention. In what follows, or where otherwise indicated, “%” will mean “weight %”, “ratio” will mean “weight ratio” and “parts” will mean “weight parts”.

The term “substantially” as used herein shall mean comprising more than 50% by weight, where relevant, unless otherwise indicated.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

Although example embodiments of the disclosed technology are explained in detail herein, it is to be understood that other embodiments are contemplated.

Accordingly, it is not intended that the disclosed technology be limited in its scope to the details of construction and arrangement of components set forth in the following description or illustrated in the drawings. The disclosed technology is capable of other embodiments and of being practiced or carried out in various ways.

### SUMMARY OF THE INVENTION

The present inventors have surprisingly discovered that edge functionalised graphene, of the type described in WO'081 and the type synthesised according to the present invention, forms an efficient thermal fluid when combined with water or water-glycol in an amount of between about 0.25 and 1.0 wt. %. It is surprisingly found that this combination of features is effective to significantly reduce the energy required to cool the composition and to increase the efficiency in which the composition transports heat.

It is found that the use of edge functionalised graphene increases the permeability of heat into the composition. The edge functionalised graphene enables it to hydrogen bond with the surrounding water molecules forming a substantially homogeneous solution. Such a solution can transport heat more effectively, which in turn increases the amount of heat the solution can absorb in a reduced timeframe and reduces the energy required to remove heat from the solution when required.

The present Inventors have unexpectedly made a significant advance in the preparation of edge functionalised graphene via a relatively green method. The use of iron(II) chloride and hydrogen peroxide over the ruthenium tetroxide and sodium periodate used in the prior art appears to have several practical advantages as noted below.

Specifically, iron(II) chloride is much cheaper than ruthenium chloride; the reaction concentration is much higher than for the method of WO'081; the solvent for the reaction is water, with no acetonitrile or ethyl acetate necessary (excluding acetonitrile and ethyl acetate means there are no flammable, toxic or expensive solvents; sodium periodate, the preferred oxidant in the WO'081 patent is exchanged for the cheaper and greener hydrogen peroxide, which can be generated directly from water and its by-product from the oxidation reaction is water, so the waste stream is less polluting; for iron containing graphites, it is likely that the reaction will be generating more iron in the filtrate than was added to the mixture, and therefore recovery will be a net positive; and the oxidised iron species are not volatile, and therefore a fully sealed system is not required to stop catalyst losses in contrast to the volatile ruthenium tetroxide.

Iron(II) chloride used in conjunction with hydrogen peroxide represents a variant of Fenton's reagent. Iron(II) is oxidised by hydrogen peroxide to iron(III), forming a hydroxyl radical and a hydroxide ion in the process. Iron(III) is then reduced back to iron(II) by another molecule of hydrogen peroxide, forming a hydroperoxyl radical and a proton. The net effect is a disproportionation of hydrogen peroxide to create two different oxygen-radical species, with water as a by-product. The free radicals generated by this process then engage in secondary reactions, in which the hydroxyl is a powerful, selective oxidant.

According to a first aspect of the present invention there is provided a method for producing dispersible edge functionalised graphene platelets, the method comprising the steps of:
a) suspending graphite or graphene in an aqueous solution; and
b) reacting the aqueous solution containing suspended graphite or graphene with an oxidant in the form of iron(II) chloride/hydrogen peroxide to at least partially functionalise edge regions of the graphite or graphene.

In an embodiment, the method further comprises the step of cooling the resultant solution obtained in step b), preferably in an ice bath.

In an embodiment, the method further comprises the step of homogenising the resultant solution obtained in step b).

In an embodiment, the homogenisation is conducted at about 20000 rpm up to 2 hours. The homogenisation can be conducted at about 5000, 10000, 15000, 20000 or 25000 rpm over a period of about 30, 60, 90, 120, 150, 180, 210, or 240 minutes. Preferably, the homogenisation step is performed at about 9000 rpm over a period of about 180 minutes.

In an embodiment, the method further comprises the step of ultrasonicating the resultant solution obtained in step b). One or more sonicators may be used with consequent increases in process efficiency.

In an embodiment, the method further comprises the step of filtering the resultant solution obtained in step b) to produce a filtered solid.

In an embodiment, the method further comprises the step of washing the filtered solid.

In an embodiment, the washing includes washing the filtered solid with HCl and/or water.

In an embodiment, the filtered solid is washed with water or dilute acid, preferably ˜1 M HC or H₂SO₄ until a filtrate produced by washing the filtered solid is colourless and then with water until the filtrate is neutral. Alternatively, washing may be effected with 0.1 M NaHCO₃ to neutralise the residual acid, then washed back to neutral with hot water.

In an embodiment, the filtered solid is washed with an organic solvent, preferably a polar organic solvent, such as ethanol or acetone.

In an embodiment, the filtered solid is dried in vacuo to produce a dried powder.

In an embodiment, the filtered solid is freeze dried to produce a dried powder of edge functionalised graphene.

In an embodiment, the dried powder is dispersed in water and sonicated for up to 30 minutes, and a resulting mixture is allowed to settle for up to 48 hours to produce a solid and a supernatant, and decanting and filtering the supernatant to produce a graphene powder.

In an embodiment, the graphene powder is washed with an organic solvent and dried.

In an embodiment, the dried powder is dispersed in water and sonicated for up to 30 minutes, and a resulting mixture is centrifuged to produce a solid and a supernatant.

In an embodiment, the graphene or graphite is provided in the form of expanded graphite with an increased interlayer spacing.

In an embodiment, the filtered solid may be dispersed in a solution containing metal ions to bind metal ions to at least one of a surface or a functionalised edge of the platelet.

In an embodiment, the metal ions are selected from Fe, Cu, Co, and Sn. Preferably, the metal ions are Fe.

In an embodiment, the iron(II) chloride is provided as FeCl₂·4H₂O.

In an embodiment, the hydrogen peroxide is provided as ˜30% H₂O₂.

In an embodiment, the inventive method gives rise to a yield of ˜95%.

In an embodiment, the graphite is provided at a concentration of up to about 150 g/L. In other embodiments, the graphite is provided at a concentration of about 145, 140, 135, 130, 125, 120, 115, 110, 105, 100, 95, 90, 85, 80, 75, 70, 65, 60, 55 or about 50 g/L.

According to a second aspect of the present invention there is provided a dispersible edge functionalised graphene platelet, when produced by a method according to the first aspect of the present invention.

In an embodiment, the dispersible edge functionalised graphene platelet exhibits advantageous conductivity and cooling capacity properties.

In an embodiment, the dispersible edge functionalised graphene platelet has: a base layer of graphene; at least one discontinuous graphene layer stacked on the base layer; wherein the at least one discontinuous layer has a smaller surface area than the base layer; and wherein the edge regions of the base layer and the at least one discontinuous layer are at least partially functionalised.

In an embodiment, the platelet is able to form a stable dispersion in water at concentrations up to about 250 mg/mL. Pastes have been observed at about 250 mg/mL in water, organic solvents, and ionic liquids. Doughs have been observed at about 350-700 mg/mL in water, organic solvents, and ionic liquids. In another embodiment, the platelet is able to form a stable dispersion in water at 250 mg/mL, a paste between 250 and 350 mg/mL and/or a dough between 350 and 700 mg/mL for at least 6 hours.

In an embodiment, the electrical conductivity of the platelet is approximately 900 S/cm, 800 S/cm, 700 S/cm, 600 S/cm, 500 S/cm, 400 S/cm, or 300 S/cm.

In an embodiment, the platelet may be further functionalised by the addition of metal ions to at least one of the functionalised edges or the surface.

In an embodiment, the metal ions are selected from Fe, Cu, Co, and Sn. Preferably, the metal ions are Fe.

According to a third aspect of the present invention there is provided a polymer-matrix composite material comprising a polymer selected from alginate, chitosan, PVA, PEG, PU, PEI, PVDF, PDMS or PEDOT PSS; and edge functionalised graphene platelets as defined according to the second aspect of the present invention.

In an embodiment, the polymer is selected from alginate, chitosan, PVA, PEG or PEDOT PSS.

According to a fourth aspect of the present invention there is provided an electrode for electrochemical processes comprising edge functionalised graphene platelets as defined according to the second aspect of the present invention; and a binder selected from Nafion and PVDF.

According to a fifth aspect of the present invention there is provided a method for producing an electrode according to the fourth aspect of the present invention, the method comprising creating a mixture containing edge functionalised graphene platelets as defined according to the second aspect of the present invention and a binder; and coating the mixture onto an electrode substrate.

According to a sixth aspect of the present invention there is provided a composition for use as a thermal fluid, the composition comprising:
a) an amount of a dispersible graphene platelet as defined according to the first aspect of the present invention including a base layer of graphene; at least one discontinuous graphene layer stacked on the base layer; wherein the at least one discontinuous layer has a smaller surface area than the base layer; and wherein the edge regions of the base layer and the at least one discontinuous layer are at least partially functionalised; and
b) a dispersion medium comprising an amount of water.

In an embodiment, the dispersible graphene platelet comprises defined central and edge regions, wherein the edge region is at least partially functionalised, and central region at least partially unfunctionalised.

In an embodiment, the amount of the dispersible graphene platelet is between about 0.1 and about 6 wt % of the composition.

In an embodiment, the amount of the dispersible graphene platelet is about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, or about 6 wt % of the composition.

In an embodiment, the water can be any desired amount, preferably from 1 to 99% by weight, which includes all values and subranges therebetween, including 1, 2, 3, 4, 5, 6, 7, 8, 9, 10, 15, 20, 25, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62. 63, 64, 65, 66, 67, 68, 69, 70, 71, 72, 73, 74, 75, 76, 77, 78, 79, 80, 85, 90, 95, 96, 97, 98, 99% by weight, based on the total weight of the composition. More preferably, the amount of water is in the range from 94 to 99.9% by weight, most preferably from 99 to 99.9% by weight. The water is preferably distilled and/or deionised. Preferably, the water is deionised before contacting with the other components of the composition.

In an embodiment, the amount of the dispersible graphene platelet is between about 0.1 and about 1 wt % of the composition.

In an embodiment, the amount of the dispersible graphene platelet is between about 0.2 and about 0.9 wt %, between about 0.3 and about 0.8 wt. %, between about 0.4 and about 0.7 wt. %, or between about 0.5 and about 0.6 wt. % of the composition.

In an embodiment, the amount of the dispersible graphene platelet is between about 0.25 and about 1 wt % of the composition.

In an embodiment, the dispersion medium further comprises one or more co-solvents.

In an embodiment, the one or more co-solvents is selected from a glycol, such as ethylene glycol, propylene glycol, 1,3-butylene glycol, hexylene glycol, diethylene glycol, di-propylene glycol or glycerin, among which ethylene glycol and propylene glycol are preferred for their chemical stability and low cost.

In an embodiment, the one or more co-solvents can be glymes, di-glymes and the like, which may elicit a similar effect to a glycol.

In an embodiment, the one or more co-solvents is selected from hexanoic acid, heptanoic acid and their salts and at least one ingredient selected from among alkylbenzoic acids having C₁-C₅ alkyl and their salts. Hexanoic acid, heptanoic acid and their salts individually have an excellent aluminium and iron corrosion inhibitory properties, and in cooperation with at least one ingredient selected from the group of alkylbenzoic acids having C₁-C₅ alkyl and their salts can excellently inhibit cavitation in a cooling system.

In an embodiment, the salts of hexanoic acid and heptanoic acid may be their alkali metal salts, ammonium salts or amine salts, among which alkali metal salts are preferred. Preferred alkali metal salts are sodium salts and potassium salts. A plurality of these chemicals may be blended in the composition of the present invention.

In an embodiment, the hexanoic acid, heptanoic acid and/or their salt or salts are blended in the composition of the present invention in a total amount of about 0.1-5.0% by weight. Less than that range will prove insufficient in prohibition of metal corrosion and cavitation while more than that range may be uneconomical.

In an embodiment, the alkylbenzoic acids having C₁-C₅ alkyl and their salts can individually inhibit metal corrosion, particularly aluminium and iron corrosion, as well as inhibit cavitation in a cooling system in cooperation with hexanoic acid, heptanoic acid and/or their salt or salts. In addition, they can individually inhibit precipitation with hard water minerals in the cooling liquid.

In an embodiment, the alkylbenzoic acids having C₁-C₅ alkyl may be p-toluic acid, p-ethylbenzoic acid, p-propylbenzoic acid, p-isopropylbenzoic acid, p-butylbenzoic acid or p-tert butylbenzoic acid. The salts of alkylbenzoic acids having C₁-C₅ alkyl may be their alkali metal salts, ammonium salts or amine salts, among which alkali metal salts such as sodium salts and potassium salts are preferred Such salts may be blended in a plurality.

In an embodiment, the alkylbenzoic acids having C₁-C₅ alkyl and/or their salts may be blended singly or in a plurality in the composition of the present invention in a total amount of about 0.1-5.0% by weight. Less than that range will be inefficient in inhibition of metal corrosion and cavitation and over that range may be uneconomical.

In an embodiment, one or more triazoles may be additionally blended, which effectively inhibit corrosion of metals, particularly copper and aluminium in a cooling system. Such triazoles are preferably selected from benzotriazol, tolyltriazol 4-phenyl-1,2,3-triazole and 2-naphthotriazol or 4-nitrobenzotriazol.

In an embodiment, the triazole or triazoles may be blended in an amount of about 0.05-1.0% by weight. Less than that range will be insufficient in inhibition of metal corrosion and more than that range may be uneconomical.

In an embodiment, the composition of the present invention may optionally be characterized by the absence of certain ingredients, namely amine salts or borates. Generation of nitrosoamine in the cooling liquid will be prevented by the absence of amine salts, while the absence of borates will contribute to lessen corrosion of aluminium and aluminium alloys.

In an embodiment, the composition may optionally and selectively comprise an antifoam and/or colorant and/or a conventional metal corrosion inhibitor or inhibitors such as molybdate, tungstate, sulfate, nitrate, mercaptobenzothiazol, or their alkali metal salts.

In an embodiment, the one or more co-solvents is ethylene glycol or propylene glycol. Preferably, the one or more co-solvents is ethylene glycol.

In an embodiment, the dispersion medium comprises water and the one or more co-solvents in an approximate 50:50 ratio by weight.

In an embodiment, the dispersion medium comprises water and the one or more co-solvents in an approximate 60:40 ratio by weight.

In an embodiment, the dispersion medium comprises water and the one or more co-solvents in an approximate 70:30 ratio by weight.

In an embodiment, the dispersion medium comprises water and the one or more co-solvents in an approximate 80:20 ratio by weight.

In an embodiment, the one or more co-solvents used can be in any desired amount, preferably from 1 to 99% by weight, which includes all values and subranges therebetween, including 1, 2, 3, 4, 5, 6, 7, 8, 9, 10, 15, 20, 25, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62. 63, 64, 65, 66, 67, 68, 69, 70, 71, 72, 73, 74, 75, 76, 77, 78, 79, 80, 85, 90, 95, 96, 97, 98, 99% by weight, based on the total weight of the composition.

In an embodiment, the composition of the present invention further comprises at least one fluorosurfactant in an amount of 0.001 to 50% by weight, which includes all values and subranges therebetween, including 0.002, 0.003, 0.004, 0,005, 0.006, 0.007, 0.008, 0.009, 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. The fluorosurfactant desirably causes a reduction in contact angle (e.g., droplet height) compared to an untreated water/glycol mixture, modifies the surface properties of liquids or solids, or reduces surface tension in a fluid or the interfacial tension between two immiscible fluids, for example oil and water. Preferably, the fluorosurfactant is soluble in water.

Preferable fluorosurfactants include, but are not limited to, the Zonyl fluorosurfactants (anionic, nonionic and amphoteric fluorinated surfactants) including, but not limited to Zonyl FSA, FSE, FSJ, FSP, TBS, FSO, FSH, FSN, FSD and FSK, more preferably the non-ionic Zonyl fluorosurfactants, most preferably Zonyl FSH, FSN or FSP (typically mixtures of a fluoroalkyl alcohol substituted polyethylene glycol with water and a glycol or glycol ether such as dipropylene glycol methyl ether). The fluorosurfactant can be used alone, or can be combined with other fluorosurfactants or non-fluorine containing surfactants as desired.

In an embodiment, a defoamer, if present, may be used in an amount sufficient to reduce buildup of foam or reduce foam or trapped air by causing the bubbles to burst, thus releasing the trapped air. Preferably the defoamer is used in an amount of from 0.01 to 50% by weight, which includes all values and subranges therebetween, including 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. One or more than one defoamer may be present. Preferable defoamers include, but are not limited to ethylene glycol n-butyl ether based defoamer, silicone emulsions, hydrocarbon oil emulsions, EO/PO copolymers and oil soluble, water miscible defoamers.

In an embodiment, the composition may comprise one or more corrosion inhibitors, in an amount sufficient to inhibit or reduce corrosion of exposed metal surfaces in contact with the composition of the present invention, preferably in an amount of from 0.01 to 50% by weight, which includes all values and subranges therebetween, including 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. Preferable corrosion inhibitors include any conventionally or commercially used corrosion inhibitor, including, but not limited to, sodium nitrate, sodium nitrite, azonitriles, dipotassium phosphate, sodium benzoate and mixtures thereof, for example. More preferably the corrosion inhibitor is an aqueous solution of nitrites, nitrates and sodium hydroxide.

In an embodiment, the composition may contain a colorant in order to help a user readily distinguish the composition from colorless liquids, particularly from water. Suitable colorants can be any conventional colorant, and can be any desired color, including but not limited to orange, blue, green, red and yellow, and any combination thereof. If present, the dye can be used in any amount to provide the color desired, preferably from 0.01 to 50% by weight, which includes all values and subranges therebetween, including 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. One or more than one dye may be present. More preferably, any light stable, transparent water soluble organic dye is suitable, including but not limited to, acid red dyes, methylene blue, uranine dye, wool yellow dye and rhodamine dye being particularly preferred.

In an embodiment, the pH of the composition may be adjusted as appropriate. Any compound that is pH active is appropriately used, and may be selected according to what is known in the art. The pH may range from 3 to 11, which includes all values and subranges therebetween, including 3.5, 4, 4.5, 5, 5.5, 6, 6.5, 7, 7.5, 8, 8.5, 9, 9.5, 10, 10.5. Aminomethyl propanol is preferable as pH adjuster. Preferably, the pH is adjusted to avoid using any of the reserve alkalinity of the corrosion inhibitor or corrosion inhibitor composition.

In an embodiment, the platelet is able to form a stable dispersion in water at concentrations up to 700 mg/mL.

In an embodiment, the electrical conductivity of the platelet is approximately 900 S/cm.

In an embodiment, the platelet is further functionalised by the addition of metal ions to at least one of the functionalised edges or the surface.

In an embodiment, the metal ions are selected from Fe, Cu, Co, and Sn.

### BRIEF DESCRIPTION OF THE FIGURES

A preferred embodiment of the present invention will now be described having reference to the accompanying drawings, in which:

FIG. 1 shows the results of a dispersibility protocol in which samples at 10 mg/mL in ˜10 mL of water were sonicated for 15 minutes then allowed to settle for 1 day. Samples 1, 2 and 3, produced by the inventive method, are shown. All other comparative samples were produced via the RuCl₂/NaIO₄ method of WO'081.

FIG. 2 shows a pressed film of a representative edge functionalised graphene, approximately 2 cm diameter, as applied in the four-point probe protocol to test conductivity and resistivity, see Table 2.

FIG. 3 shows the inline set up of the Silverson homogeniser. The homogeniser appears to give comparable or better quality edge functionalised graphene with regard to electrical and thermal conductivities.

FIG. 4 is a diagram of a cooling loop set up, where “Flow” indicates an inline flow sensor, and “Temp” indicates two inline temperature sensors, which are equidistant (C=D) from the radiator. A cooling loop was established to test coolant efficacy, using a computer to monitor temperatures and flow. Coolant was pumped through the system to a radiator with temperature sensors at the inlet and outlet. The coolant temperature was raised to 50° C. and the two radiator fans were turned on to 2000 rpm to remove the heat from the cooling loop down to lower the 30° C. The temperature difference between the inlet and outlet of the radiator was monitored, as was the flow rate.

FIG. 5 shows comparisons of ΔT across radiator at 45° C. (blue) and 31° C. (orange) as measured at radiator inlet for dispersions of RuCl₂/NaIO₄ generated sample 2 in water as a relative percentage increase. Flow rate is indicated by the grey line.

FIG. 6 shows comparisons of ΔT across radiator at 45° C. (blue) and 31° C. (orange) as measured at radiator inlet for inventive sample 1 dispersions in water as a relative percentage increase. Flow rate is indicated by the grey line.

FIG. 7 shows comparisons of ΔT across radiator at 45° C. (blue) and 31° C. (orange) as measured at radiator inlet for inventive sample 1 dispersions in water, where each point is an average (n=3). Flow rate is indicated by the grey line.

FIG. 8 shows a schematic representation of a dispersible graphene platelet made by the method according to the present invention.

FIG. 9 compares thermal conductivities of the EFG produced by the RuCl₂/NaIO₄ method (WO'081) with those of the present invention at various concentrations in water. It can be seen that the results obtained were similar for both species.

FIG. 10 shows the Raman spectrum of EFG produced according to the present invention. Typical ID/IG ratios at the edge for Fenton EFG are ˜0.1 and at the centre are ˜0.05, similar to the EFGs formed via the ruthenium tetroxide method.

FIG. 11 shows SEM images of EFGs produced according to the present invention, specifically (a) 50,000× magnification, with the bar representing 100 nm; (b) 1000× magnification, with the bar representing 10 μm; (c) 500× magnification, with the bar representing 10 μm; and (d) 5000× magnification, with the bar representing 1 μm.

FIG. 12 compares the effect of 3% w/w EFG in 3:7 ethylene glycol/water on cooling in a PC set up. The data show that the sample is more stable than that obtained previously, allowing a trendline to be drawn through with R2 values >0.99.

### EXPERIMENTAL

A 5 L beaker was filled with 4 L of water, after which 300 g of graphite and 15 g of FeCl₂·4H₂O was added. 100 mL of 30% w/w H₂O₂ in water was then added slowly, resulting in gas evolution and a colour change from yellow/orange to brown. The mixture was left for 30 minutes until most of the bubbling had subsided, and the solution had turned a pale red. The mixture was then cooled with an ice bath and homogenised for 1.5 hours at 9000 rpm.

Following this, the mixture was sonicated for 2.5 hours. To the mixture was then added 100 mL of 30% w/w H₂O₂ solution and the mixture was further sonicated for 2.5 hours. 500 mL of 1 M HCl was then added to the mixture with stirring, and the solid left for 2 h to settle after which the supernatant was decanted. 500 mL of 1 M HCl was again added, and the mixture was filtered through a 0.45 μm polypropylene filter to give a solid black filter cake.

The filter cake was then washed with 250 mL 1 M HCl portions until the filtrate was colourless, after which it was washed with 500 ml of water, then 2×250 mL 0.1 M NaHCO₃. The filter cake was then washed with hot water until the pH of the filtrate was <8.5. The filter cake was then washed with acetone, and the filter cake was then dried in vacuo to give a black powder containing edge functionalised graphene platelets.

TABLE 1
Inventive and comparative samples of edge functionalised graphene

| | Method of | | Graphite | |
|---|---|---|---|---|
| Sample | synthesis | Oxidant | source | Comments |
| 1 | Invention | FeCl₂/H₂O₂ | TFG1 | |
| 2 | Prior art | RuO₄/NaIO₄ | TFG1 | Method described in |
| | | | | WO'081; 100% |
| | | | | amplitude sonication |
| | | | | for 5 h. RuO₄ distilled |
| | | | | directly from reaction |
| | | | | mixture |

TFG1: Thomas Groizer and Son Pty Ltd Flake No. 1

As can be seen from Table 1, comparative samples of edge functionalised graphene were produced according to the method of the present invention as described above. A single sample was produced for comparative purposes by the method as described broadly in WO'081.

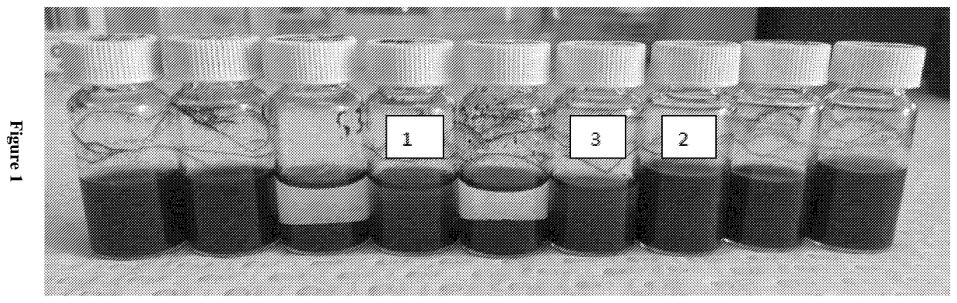

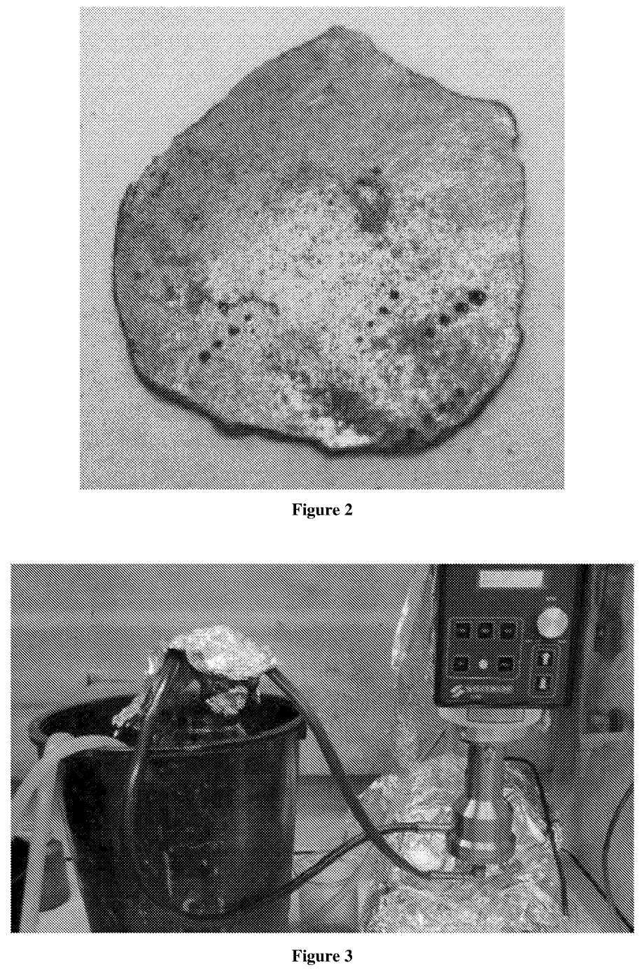

Having regard to FIG. 1, platelet samples were tested for dispersibility. Comparative sample 2 displayed the best dispersibility over 24 hours, giving rise to a relatively even dispersion. Inventive sample 1 settled completely within 24 hours. The initial results demonstrate that further modification and optimisation of the reaction parameters of the inventive method is necessary in order to achieve comparable dispersibility to the sample obtained via the method of WO'081.

A four-point probe protocol was conducted upon samples 1 and 2. Having regard to FIG. 2, films were formed by pressing 0.5 g of edge functionalised graphene powder at 133 kg/cm² pressure in a hot press, which gave approximate circles with a diameter of ˜2 cm and a thickness of ˜500 μm. These films were brittle but held together well enough for conductivity measurements.

The effect of graphitic particle size was demonstrated by sieving TFG1 into two particle size distributions: >200 μm and <200 μm. The larger particle size provided an EFG product showing slightly less dispersibility at 4 days. The conductivity of the sample was better by comparison with that derived from the smaller sized TFG1.

TABLE 2
Film conductivities as measured by a four-point probe

| | | Sheet | | |
|---|---|---|---|---|
| | | resistivity | | |
| | Method of | (mOhm/ | Conductivity | |
| Sample | synthesis | square) | (S/cm) | Comments |
| 1 | Invention | 60-90 | 3 × 10²- | Conductivity: |
| | | | 2 × 10² | correction |
| 2 | Prior art | 60-90 | 3 × 10²- | factor of 0.849 |
| | | | 2 × 10² | applied |

The data obtained for inventive sample 1 mirrored that of sample 2 obtained by the prior art method of WO'081.

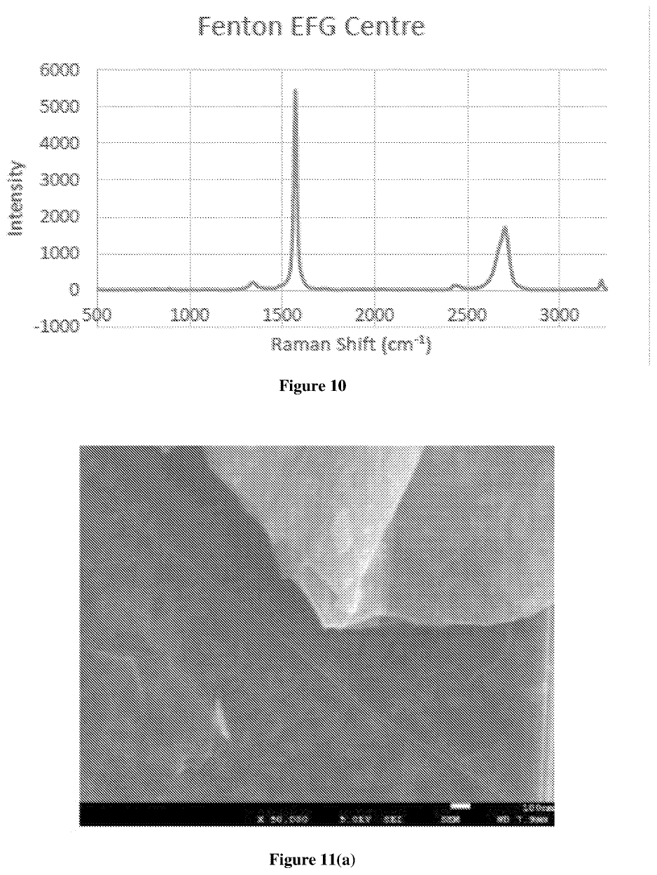

In order to test thermal conductivities, a range of samples were tested at 0.25-1.0% w/w loading in water, and their thermal conductivities were compared to that of water. The method was that ˜25-100 mg of an edge functionalised graphene sample was loaded into a vial with ˜10 g of Milli-Q water, and the samples were sonicated for 15 minutes. Before testing in a C-Therm Conductivity Analyser, the mixture was shaken and mixed before the sample was pipetted into the measurement well. The thermal conductivity data obtained from the C-Therm Conductivity Analyser is given in Table 3 and FIG. 10. The best performing EFGs gave a ≥50% increase in thermal conductivity at 1% w/w loading over water.

In general, the inventive Fenton EFGs had similar thermal conductivities and electrical conductivities, but lower dispersibility than the RuCl₂/NaIO₄ products. This chemistry results in an edge functionalised graphene sample that appears to be a viable coolant additive as discussed below.

TABLE 3
Thermal conductivities as measured by C-Therm thermal analyser

| | EFG | | % increase | K | % increase |
|---|---|---|---|---|---|
| Method | (% w/w) | Effusivity | v water | (W/mK) | v water |
| | 0 | 1578 | 0 | 0.59 | 0 |
| Ru/NaIO₄ | 0.25 | 1702 | 7.85 | 0.67 | 13.55 |
| Ru/NaIO₄ | 0.5 | 1931 | 22.37 | 0.84 | 42.37 |
| Ru/NaIO₄ | 1.0 | 2080 | 31.81 | 0.96 | 62.71 |
| FeCl₂/H₂O₂ | 0.25 | 1626 | 3.04 | 0.62 | 5.08 |
| FeCl₂/H₂O₂ | 0.5 | 1850 | 17.23 | 0.77 | 30.50 |
| FeCl₂/H₂O₂ | 1.0 | 1991 | 26.17 | 0.89 | 50.84 |

Switching to a flow homogeniser does account for an observed thermal conductivity drop when scaling, wherein the use of Silverson flow homogeniser at 60 g in sample 1 gives a thermal conductivity of 0.83 W/mK and an effusivity of 1919 on a 5 g scale (see, Table 3). This could be a result of the unique chemistry used to make these edge functionalised graphene samples.

A settling study was also conducted, where sonicated samples 1 (invention) and 2 (prior art) were left for 2 hours, after which a portion of the dispersion was taken from the centre of the vial and tested with the conductivity analyser. After this, the samples were shaken and the sample once again tested. The principal disadvantage of the inventive Fenton chemistry becomes apparent when comparing sample 2 (Ru/NaIO₄ system) and sample 1 (Fe/H₂O₂). After 2 hours of settling, almost all of sample 1 had settled out of solution, and so sampling from the middle of the vial gave almost entirely water, with a thermal conductivity of 0.61 W/mK. Sample 2 had much better dispersion stability in contrast and had a thermal conductivity of 0.89 W/mK which was still superior to water by a significant margin (48%). Upon shaking, Samples 1 and 2 show that most of the thermal conductivity has been restored. However, the inventive Fenton chemistry sample still underperformed compared to their initial thermal conductivity.

The results demonstrate that thermal conductivity analysis is a valuable tool for investigating the differences between different edge functionalised graphene samples. A 60% increase in thermal conductivity relative to water has been realised with edge functionalised graphene sample 1 produced via the present invention.

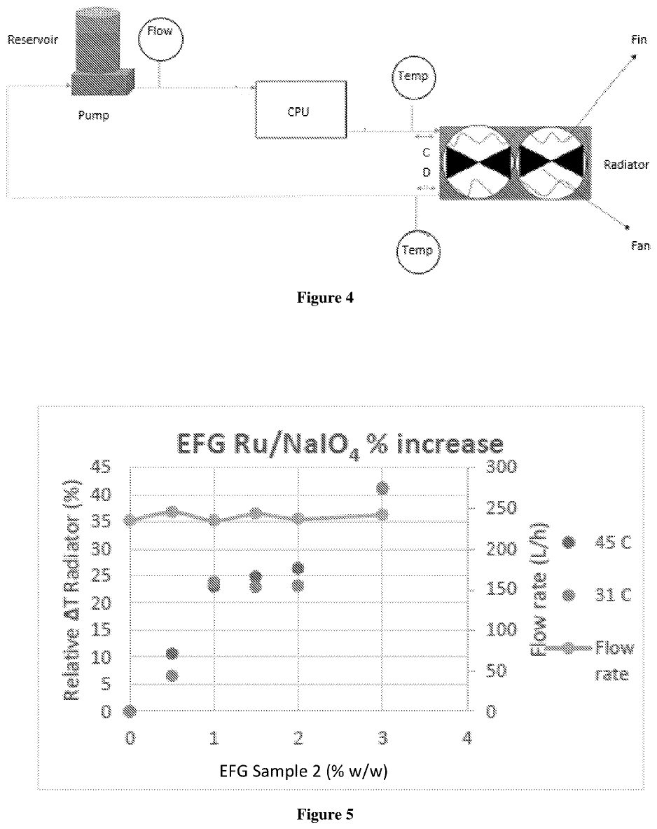

A cooling loop was established to test coolant efficacy, using a computer to monitor temperatures and flow (see, FIG. 4). Coolant was pumped through the system to a radiator with temperature sensors at the inlet and outlet. The coolant temperature was raised to 50° C. and the two radiator fans were turned on to 2000 rpm to remove the heat from the cooling loop down to lower the 30° C. The temperature difference between the inlet and outlet of the radiator was monitored, as was the flow rate.

TABLE 4
C-Therm thermal conductivity analyser results for settling study

| | Method of | | EFG | K | % increase | | % increase |
|---|---|---|---|---|---|---|---|
| Sample | synthesis | Notes | (wt. % ) | (W/mK) | v water | Effusivity | v water |
| Water | — | — | 0 | 0.60 | — | 1594 | — |
| 1 | Invention | — | 1 | 0.97 | 60 | 2082 | 31 |
| 1 | Invention | 2 h post- | 1 | 0.89 | 48 | 2000 | 26 |
| | | settling | | | | | |
| 1 | Invention | Re-mixed | 1 | 0.94 | 56 | 2056 | 29 |
| 2 | Prior art | — | 1 | 0.98 | 62 | 2094 | 31 |
| 2 | Prior art | 2 h post- | 1 | 0.61 | 0 | 1603 | 1 |
| | | settling | | | | | |
| 2 | Prior art | Re-mixed | 1 | 0.87 | 44 | 1969 | 24 |

FIG. 5 shows comparisons of ΔT across radiator at 45° C. (blue) and 31° C. (orange) as measured at radiator inlet for prior art sample 1 dispersions in water as a relative percentage increase. Flow rate is indicated by the grey line. As can be seen, for the Ru/NaIO₄ synthesis of edge functionalised graphene, a >40% increase over water across the radiator could be realised with 3% w/w loading in water, and a >20% increase could be realised with 1% w/w loading. This is lower than expected, however, as the thermal conductivity data in Table 3 indicated that the thermal conductivity relative to water should have resulted in a 60% increase at just 1% w/w loading.

Given the results, the exclusion of certain variables in the system was investigated. Previous experiments were re-analysed and a new set of experiments carried out, with the purpose of analysing the temperature difference between the radiator inlet and outlet at comparable (c.10%) flow rates.

Since the inventive sample 1 had a similar thermal conductivity to the prior art sample 2 when dispersed, this edge functionalised graphene sample was next tested in the system.

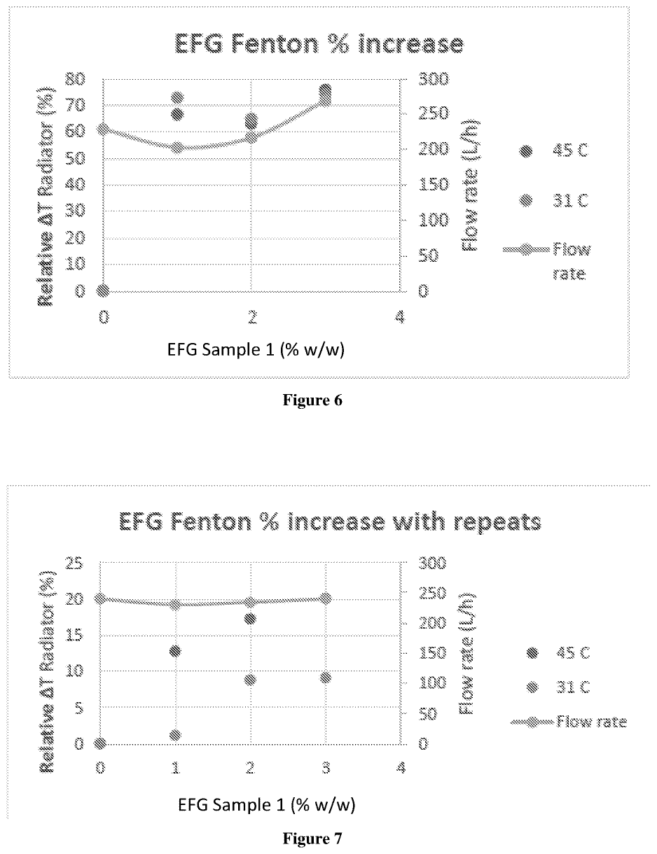

FIG. 6 shows comparisons of ΔT across radiator at 45° C. (blue) and 31° C. (orange) as measured at radiator inlet for sample 1 dispersions in water as a relative percentage increase. Flow rate is indicated by the grey line.

In analysing the results, the Inventors were concerned that the water run gave unusually low results and that there was no clear increase with increasing sample loading. Accordingly, the process was modified to three runs per percentage sample loading. This showed a significant difference with the results shown in FIG. 6, potentially as a function of the increased time it took to run the experiment. In so doing, the edge functionalised graphene sample could have been increasingly less homogeneously dispersed.

FIG. 7 shows comparisons of ΔT across radiator at 45° C. (blue) and 31° C. (orange) as measured at radiator inlet for sample 1 dispersions in water, where each point is an average (n=3). Flow rate is indicated by the grey line. The result indicated an improvement, with ˜20% increase in thermal conductivity over plain water with 3% w/w loading in the dispersion, the dispersibility of the product likely needs further improvement to fully realise the potential of this reaction.

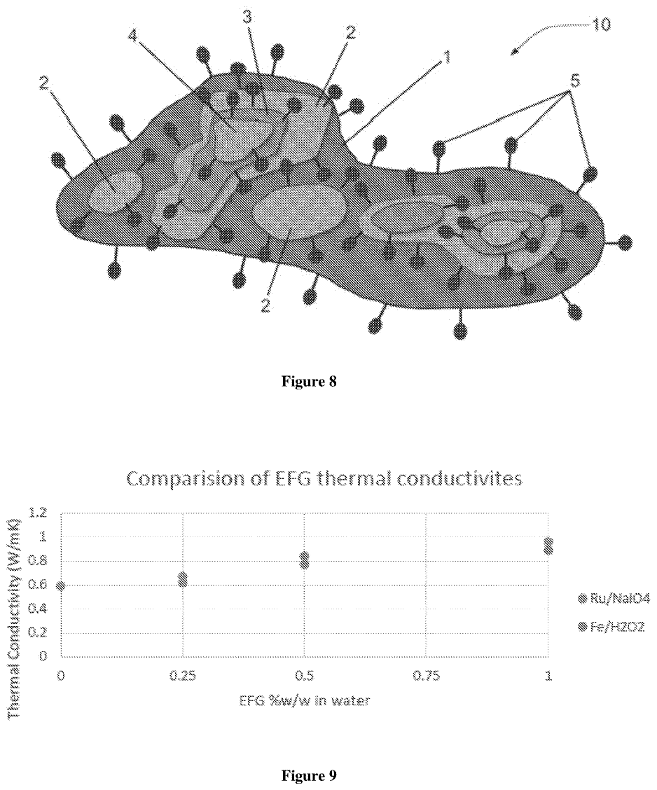

FIG. 8 shows a schematic view of a dispersible graphene platelet 10, as made according to the present invention. The base graphene layer 1 is sized at a micron level, and features functionalised groups 5 such as hydroxyl or carboxyl acids around its edges. Platelet 10 further includes a discontinuous graphene layer 2 stacked on the surface of base layer 1. Further discontinuous graphene layers 3 and 4 are stacked on top of layer 2, the surface area of each discontinuous layer may be smaller relative to the layer below it. The edges of each discontinuous layer also feature a degree of functionalisation in the form of functionalised groups 5.

FIG. 9 should be considered in conjunction with Table 3, above, and compares thermal conductivities of the EFG produced by the Ru/NaIO₄ method (WO'081) with those of the present invention at various concentrations in water. It can be seen that the results obtained were similar for both species. The inventive Fenton EFG at 1.0% w/w loading in water, gave effusivity and thermal conductivity measurements that compare acceptably to those of EFG produced by the process of WO'081.

FIG. 10 shows the Raman spectrum of an EFG sample produced according to the present invention. Typical ID/IG ratios at the edge for Fenton EFG are ˜0.1 and at the centre are ˜0.05, similar to the EFGs formed via the ruthenium tetroxide method.

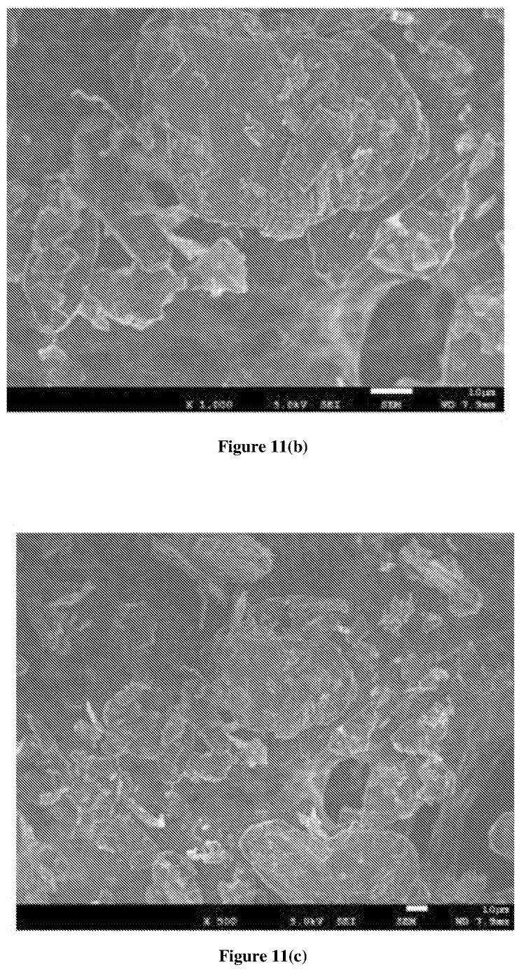

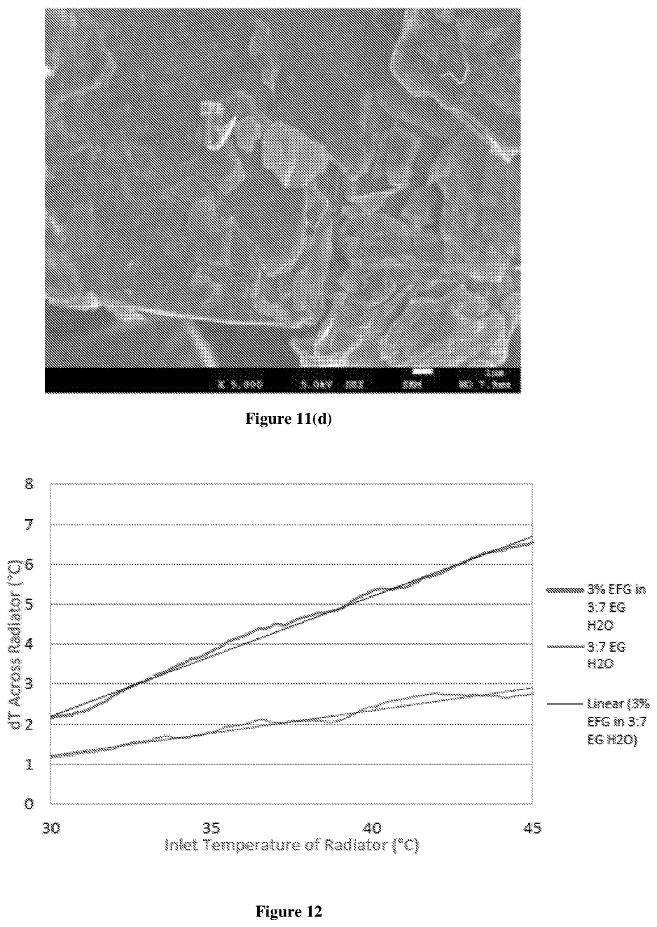

Finally, FIG. 11 shows SEM images of EFGs produced according to the present invention, specifically (a) 50,000× magnification, with the bar representing 100 nm; (b) 1000× magnification, with the bar representing 10 μm; (c) 500× magnification, with the bar representing 10 μm; and (d) 5000× magnification, with the bar representing 1 μm.

In conclusion, the inventive Fenton chemistry appears to be a promising candidate for improving thermal conductivity of coolants.

TABLE 5
Comparison of EFGs produced by a) the inventive
method; b) WO'081 and c) Agarwal, et al.

| | Agarwal, et al. | Present invention | WO'081 |
|---|---|---|---|
| Reagent/solvent | Weight | Weight | |
| Graphite (conc.) | 8 g (0.4 g/L) | 300 g (71.4 g/L) | 20 (14.3 g/L) |
| Relative solvent increase | 187.5 | 1 | 5.24 |
| Water | 20 L | 4 L | 0.6 L |
| Ethyl acetate | — | — | 0.4 L |
| Acetonitrile | — | — | 0.4 L |
| Oxidant | 180 mL (30% H₂O₂) | 200 mL (30% H₂O₂) | 20 g NaIO₄ |
| Oxidant per graphite (% w/w) | 750 | 22 | 100 |
| Fe (salt used) | 1.79 g (8.9 g | 4.21 g (15 g | — |
| | FeSO₄•7H₂O) | FeCl₂•4H₂O) | |
| Ru (species) | — | — | 0.33 g (0.82 g |
| | | | RuCl₃•xH₂O) |
| Fe or Ru to graphite (% w/w) | 22% | 1.4% | 1.64% |
| Yield | 45-48% | 95% | 95% |

A comparison of the EFGs obtained by the method of Agarwal, et al., that of WO'081, and that of the present invention was undertaken. Comparing the work of Agarwal et al. to the present invention, one can readily appreciate that: the scale is lower, 8 g cf. 300 g; graphite concentration is much lower, 0.4 g/L cf. 71.4 g/L; oxidant loading is much higher, 750% against 22%; the iron content required is much higher, 22% cf. 1.4%; organic solvent is used (DMF); centrifuging is required, and is done on large volumes of DMF, with 4 L of DMF required per gram of graphene and which then needs to be evaporated off; the yield is lower, 45-48% cf. 95%; the dispersal of platelets is significantly lower, at 0.25 mg/mL in DMF, whereas Fenton EFG forms dispersions up to 100 mg/mL in water and other organic solvents; Fenton EFG forms inks and doughs as well, there is no evidence that the Agarwal graphene is capable of doing this; and there is no evidence that Agarwal graphene has amphiphilic properties as Fenton EFG does.

TABLE 6
Other properties of EFG produced by the inventive method

| Property | Value | | Instrument |
|---|---|---|---|
| Conductivity | ~450 | S/cm | 4-point probe on |
| | | | pressed film |
| Tₘₐₓ | ~800° | C. | TGA |

| | | |
|---|---|---|
| Ash content | ~3.9% | TGA |
| Labile groups/loss | ~0% | TGA |
| under N₂ | | |
| Impurities % | Fe: 0.006% | ICP |
| | Al: 0.09% | ICP |
| | Si: 1.2% | XPS |
| Thermal conductivity | ~0.9 W/mK at 1% | C-therm thermal |
| | w/w in water | conductivity analyser |
| Thermal effusivity | ~2000 Ws^{1/2}/m²K | C-therm thermal |
| | at 1% w/w in water | conductivity analyser |
| Dispersibility | ~2 h at 1% w/w EFG | |
| (aqueous; pH 7) | | |

### DETAILED DESCRIPTION OF A PREFERRED EMBODIMENT

The present disclosure will become better understood from the following example of a non-limiting embodiment of a method for producing edge functionalised graphene platelets.

The present invention generally provides a method for producing dispersible graphene platelets, the method comprising the steps of suspending graphite or graphene in an aqueous solution; and reacting the solution containing suspended graphite or graphene with an oxidant in the form of iron(II) chloride/hydrogen peroxide to at least partially functionalise edge regions of the graphite or graphene.

Iron(II) chloride/hydrogen peroxide is used as the oxidant for functionalising the edges of the graphene platelets. FeCl₂/H₂O₂ is suitable owing to its strong oxidation effects, facilitating the partial conversion of the outermost rings of the graphene structure to carboxylic acids or phenols while leaving the inner structure unmodified.

It will be appreciated by those skilled in the art that other salts of Fe can be used with H₂O₂ (such as FeCl₃ and FeSO₄). Moreover, salts of other metals such as CuSO₄, MnO₂ and RuCl₂ can be used with H₂O₂ to achieve Fenton-like reactions for EFG formation.

Advantages of the present invention include the fact that iron(II) chloride is much cheaper than ruthenium chloride; the reaction concentration is much higher than for the method of WO'081; the solvent for the reaction is water, with no acetonitrile or ethyl acetate necessary (excluding acetonitrile and ethyl acetate means there are no flammable, toxic or expensive solvents; sodium periodate, the preferred oxidant in the WO'081 patent is exchanged for the cheaper and greener hydrogen peroxide, which can be generated directly from water and its by-product from its oxidation reaction is water, so the waste stream is less polluting; for iron containing graphites, it is likely that the reaction will be generating more iron in the filtrate than was added to the mixture, and therefore recovery will be a net positive; and the oxidised iron species are not volatile, and therefore a fully sealed system is not required to stop catalyst losses in contrast to the volatile ruthenium tetroxide.

The dispersible graphene platelets produced by the method of the present invention have a structure containing a base layer of graphene at a micron scale. On the surface of this base layer are irregular nanometer-sized graphene layers which may be stacked as high as two to nine layers above the base layer. Otherwise stated, the structure comprises a base layer of graphene on which at least one discontinuous layer of graphene is stacked, with each layer of graphene above the base layer having a smaller surface area than the layer it is stacked upon. The edges of the base layer and the edges of the discontinuous layers stacked upon it are all at least partially functionalised, providing a structure with graphene-like properties due to the defect free basal planes and improved dispersibility owing to the functional groups on the edges of each graphene layer.

FIG. 8 shows a schematic view of a dispersible graphene platelet 10. The base graphene layer 1 is sized at a micron level, and features functionalised groups 5 such as hydroxyl or carboxyl groups around its edges. Platelet 10 further includes a discontinuous graphene layer 2 stacked on the surface of base layer 1. Further discontinuous graphene layers 3 and 4 are stacked on top of layer 2, the surface area of each discontinuous layer may be smaller relative to the layer below it. The edges of each discontinuous layer also feature a degree of functionalisation in the form of functionalised groups 5.

In a preferred embodiment, the graphite used to produce the dispersible graphene platelets may be first thermally expanded to increase the interlayer spacing prior to being placed in solution. This may, in one non-limiting example, be carried out at temperatures between 700-1000° C. Graphite treated in this way is commonly referred to as expanded graphite.

A dispersion of the edge functionalised graphene provided by the above two methods may be used to produce electrically-conducting materials. For instance, it may be desirable to use these platelets to fabricate electrodes for electrochemical processes using a mixture of a dispersion of platelets with a binder such as Nafion or PVDF and coating the resultant mixture onto an electrode surface. An electrode produced in this manner could then be used in a battery or in electrochemical processes such as CO₂ reduction. With the structure of the platelets established, experiments were carried out to measure the dispersibility and conductivity of the platelets.

For suspensions with a relatively high proportions of graphene platelets to solvent, the nature of the resultant solution may change. Suspensions of the edge functionalised graphene platelets with more than 25 wt. % edge functionalised graphene in water have been found to form a paste, while suspensions with more than 35 wt. % edge functionalised graphene in water have been found to form a moldable dough. The ability of the resultant dough to be moulded allows the forming of almost any shape from the material. Pastes have been observed at 250 mg/mL in water, organic solvents, and ionic liquids. Doughs have been observed at 350-700 mg/mL in water, organic solvents, and ionic liquids.

The sixth aspect of the present invention provides a composition for use as a thermal fluid, the composition comprising:
a) an amount of a dispersible graphene platelet including a base layer of graphene as defined according to the first aspect of the invention; at least one discontinuous graphene layer stacked on the base layer; wherein the at least one discontinuous layer has a smaller surface area than the base layer; and wherein the edge regions of the base layer and the at least one discontinuous layer are at least partially functionalised; and
b) a dispersion medium comprising an amount of water.

The amount of the dispersible graphene platelet is between about 0.1 and about 6 wt % of the composition, but is shown through empirically modelled data to be most optimally between about 0.25 and about 1 wt. %.

The dispersion medium is preferably water, or may be water and ethylene or propylene glycol in an approximate volume ration of about 70:30.

As described above, one or more co-solvents may be added to the composition.

Such co-solvents comprise glycols, alcohols, surfactants, dyes, defoamers, acids, bases and the like.

Thermal Analysis Labs (TAL) conducted calorimetry and thermal conductivity analyses of nine compositions of edge functionalised graphene in 70:30 water/ethylene glycol as described above in respect of the dispersion medium. The data are provided in Table 7, below.

TABLE 7
Calorimetry and thermal conductivity report data

| | Thermal | | | Specific | Thermal | |
|---|---|---|---|---|---|---|
| | effusivity | | | heat | conductivity | |
| Sample | (Ws^{1/2}m⁻²K⁻¹) | | Density | capacity | (W/mK) | |
| (EFG %) | Measured | RSD | (kg/m³) | (J/kgK) | Calculated | RSD |
| 0% | 1306 | 0.4% | 1020 | 3840 | 0.431 | 0.9% |
| 0.25% | 1018 | 0.3% | 1030 | 2780 | 0.365 | 0.5% |
| 0.5% | 1492 | 0.5% | 1030 | 3450 | 0.633 | 1.0% |
| 0.75% | 1591 | 0.3% | 1030 | 3770 | 0.658 | 0.5% |
| 1% | 1855 | 0.2% | 1030 | 3720 | 0.907 | 0.5% |
| 1.25% | 1921 | 0.3% | 1030 | 3580 | 1.010 | 0.6% |
| 1.5% | 2014 | 1.2% | 1030 | 3580 | 1.111 | 2.4% |
| 2% | 2130 | 0.3% | 1030 | 3600 | 1.236 | 0.7% |
| 5% | 2298 | 0.4% | 1030 | 3580 | 1.446 | 0.8% |

* EFG = edge functionalised graphene

The data obtained above were used to model the potential energy savings applicable to a data centre. These data are disclosed in AU 2021904251, filed 23 Dec. 2021, the content of which is incorporated herein by reference. In particular, the data demonstrate that annual energy savings between about 10 and about 50% may be achievable using thermal fluids as described in the present invention, in concentrations ranging from about 0.25 to about 1 wt. %. Energy savings beyond about 1 wt. % edge functionalised graphene are less pronounced, suggesting that the optimal concentration of edge functionalised graphene in 70:30 water/ethylene glycol is between about 0.2 and about 1 wt. %.

Based upon the data, several conclusions may be reached: Thermal performance increases with an increase in edge functionalised graphene composition; it probable that the optimum composition ranges between 0.25 and <1 wt. %; the edge functionalised graphene thermal fluid offers increased heat rejection in the range of the cooling tower, thereby lowering the energy usage of a data centre; estimated annual energy reduction ranges from ˜15% to ˜30% (at edge functionalised graphene concentrations from 0.25 to 0.75 wt. %); and of most commercial significance, edge functionalised graphene may allow existing and future data centre cooling systems to achieve a significant improvement in heat rejection performance, energy saving and cost reduction.

An additional set of experiments on a PC cooling rig was carried out, this time in a 3:7 ethylene glycol mix, utilising the inventive EFG. Interestingly, the raw data (FIG. 12) demonstrate that the sample is much more stable than that obtained previously, allowing a trendline to be drawn through with R2 values >0.99. Without wishing to be bound by theory, it is thought that this may be attributable to the smaller particle size combined with better dispersibility.

The outcome was that EFG in ethylene glycol/water gave promising data in the PC cooling system, with excellent improvements in thermal conductivity with increased EFG content.

Coin Cells with EFG

Due to its properties, EFG was considered as a replacement for carbon black in coin cells. Testing showed that the inventive 0.5% Fenton EFG gave an approximate 50% increase in energy performance after 20 cycles.

### Scaled-Up Synthesis of EFG Via Inventive Method

The inventors have successfully scaled up the inventive method as shown below.

TABLE 8
Reagents and solvents used in scale-up EFG synthesis

| | |
|---|---|
| Reagent/solvent | Mass/volume |

| Graphite | 3.0 kg (added by 1 kg per L | |
|---|---|---|
| | water, 1 L to was in residue | |
| Iron chloride anhydrous in water | 98 g in 1 L water | |
| Hydrogen peroxide (30% v/v) | 0.45 L × 4 | |
| Water | 30 | L |
| 1M HCl | 30 | mL |

The resulting EFG was comparable to that of smaller-scale standard EFG, with good dispersibility and conductivity profiles. The resulting EFG was further characterised by x-ray diffraction (XRD), from which the 2H and 3R peak ratio may provide insight as to the level of disorder in the EFG. Shown below is a comparison of 2H v. 3R, and the corresponding electrical conductivity as measured by a 4-point probe.

XRD was carried out on a range of EFGs, with the 2H to 3R ratio calculated on Highscore by Rietveld refinement, and are presented below in Table 9. The 3R stacking is a more disordered structure, introduced during homogenisation and sonication, which is apparent in the inventive EFG samples (but not TGF1). A notable feature of this data is that as the reaction is scaled up, the 3R peak increased, which is indicative of more disorder being introduced to the EFG. As such, this peak is likely a good indication of the extent of the reaction (as is seen from the comparison with TGF1).

TABLE 9
Comparison of 2H and 3R structure of selected samples

| Sample | Scale | | 2H (%) | 3R (%) | Conductivity (S/cm) |
|---|---|---|---|---|---|
| TFG1 | — | | ~100 | ~0 | — |
| Sample 1 | 60 | g | 72.5 | 37.5 | — |
| Sample 2 | 60 | g | 73.7 | 26.3 | 267 |
| Sample 3 | 400 | g | 64.4 | 35.6 | 256 |
| Sample 4 | 1.5 | kg | 67.2 | 32.8 | — |
| Sample 5^{a} | 400 | g | Unclear | Unclear | 425 |

^{a}Sample was double-sonicated as described above

In respect of the conductivity measurements versus the level of disorder introduced during synthesis, a caveat is that larger particle size results in generally more robust films when pressed, meaning this may not be the best comparison if the particle size is different. The one sample that bucks this trend though is “Sample 5” where two simultaneous sonicators resulted in smaller particle sizes, yet the more graphenic particles result in higher conductivity, indicating an excellent EFG. These results show differences between EFGs as well as the graphites.

The inventive outcomes were twofold. Firstly, that the ratio between 2H and 3R phases in XRD appears to be a valuable characterisation tool with which to compare EFGs; and secondly, that conductivity of EFG films as measured by 4-point probe has much to do with particle packing, and so should only be used on similar particle size distribution EFGs for comparison.

The dispersible graphene platelet has a structure containing a base layer of graphene at a micron scale. On the surface of this base layer are irregular nanometer sized graphene layers which may be stacked as high as seven to nine layers above the base layer. Otherwise stated, the structure comprises a base layer of graphene on which at least one discontinuous layer of graphene is stacked, with each layer of graphene above the base layer having a smaller surface area than the layer it is stacked upon. The edges of the base layer and the discontinuous layers stacked upon it are all at least partially functionalised, providing a structure with graphene-like properties owing to the base layer and improved dispersibility owing to the increased amount of functionalised groups on each platelet.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose.

In addition, the foregoing describes only some embodiments of the invention, and alterations, modifications, additions and/or changes can be made thereto without departing from the scope and spirit of the disclosed embodiments, the embodiments being illustrative and not restrictive.

Although the invention has been described with reference to specific examples it will be appreciated by those skilled in the art that the invention may be embodied in many other forms.

### INDUSTRIAL APPLICABILITY

Those of skill in the art will readily appreciate the industrial applicability of an improved method for the production of edge functionalised graphene platelets, which engender great potential in high thermal conductivity and high dispersibility applications such as batteries.

Relative costings of the inventive method versus the ruthenium tetroxide method characterised by WO'081 have been modelled as shown below. Roughly, the unit cost of the inventive method is about 3.8% that of the ruthenium method (even at 90% Ru recycling).

TABLE 10
Relative cost of inventive method
versus ruthenium (WO'081) method

| | |
|---|---|
| Inventive method | Ruthenium (WO'081) method |

| Reagent | US$/kg EFG | Reagent | US$/kg EFG |
|---|---|---|---|
| Graphite | 1.75 | Graphite | 1.75 |
| H₂O₂ | 0.80 | NaIO₄ | 40.00 |
| FeCl₂ | 0.20 | RuCl₃ (90% recyc.) | 28.00 |
| H₂SO₄ | 0.14 | HCl | 0.77 |
| NaHCO₃ | 0.006 | EtOAc | 0.27 |
| | | NaHCO₃ | 1.20 |
| | | MeCN | 4.20 |
| Total | $2.90 | Total | $76.19 |

1. A method for producing dispersible edge functionalised graphene platelets, the method comprising the steps of:
a) suspending graphite or graphene in an aqueous solution; and
b) reacting the aqueous solution containing suspended graphite or graphene with an oxidant in the form of iron(II) chloride/hydrogen peroxide to at least partially functionalise edge regions of the graphite or graphene.

2. (canceled)

3. A method according to claim 1, further comprising the step of homogenising the resultant solution obtained in step b).

4. (canceled)

5. A method according to claim 1, further comprising the step of ultrasonicating the resultant solution obtained in step b);
filtering the resultant solution obtained in step b) to produce a filtered solid; washing the filtered solid with HCl and/or water until a filtrate produced by washing the filtered solid is colourless and then with water until the filtrate is neutral;
drying the filtered solid in vacuo to produce a dried powder;
dispersing the dried powder in water, sonicating for up to 30 minutes;
allowing a resulting mixture to settle for up to 48 hours to produce a solid and a supernatant; and
decanting and filtering the supernatant to produce a graphene powder.

6. (canceled)

7. (canceled)

8. (canceled)

9. (canceled)

10. (canceled)

11. (canceled)

12. The method according to claim 3, wherein the graphene powder is washed with an organic solvent and dried, wherein the dried powder is dispersed in water and sonicated for up to 30 minutes, and a resulting mixture is centrifuged to produce a solid and a supernatant.

13. (canceled)

14. The method according to claim 1, wherein the graphene or graphite is provided in the form of expanded graphite with an increased interlayer spacing.

15. The method according to claim 9, wherein the filtered solid is then dispersed in a solution containing metal ions to bind metal ions to at least one of a surface or a functionalised edge of the platelet.

16. The method according to claim 15, where the metal ions are selected from Fe, Cu, Co, and Sn.

17. The method according to claim 1, wherein the iron(II) chloride is provided as FeCl₂·4H₂O.

18. The method according to claim 1, wherein the hydrogen peroxide is provided as ˜30% H₂O₂.

19. The method according to claim 1, wherein the graphite is provided at a concentration of up to about 150 g/L.

20. A dispersible edge functionalised graphene platelet, when produced by a method according to claim 1.

21. The dispersible edge functionalised graphene platelet according to claim 20, having:
a base layer of graphene;
at least one discontinuous graphene layer stacked on the base layer;
wherein the at least one discontinuous layer has a smaller surface area than the base layer; and,
wherein the edge regions of the base layer and the at least one discontinuous layer are at least partially functionalised.

22. The dispersible edge functionalised graphene platelet according to claim 20, wherein the platelet is able to form a stable dispersion in water at concentrations up to 250 mg/mL, a paste between 250 and 350 mg/mL and/or a dough between 350 and 700 mg/mL for at least 6 hours.

23. The dispersible edge functionalised graphene platelet according to claim 20, wherein the electrical conductivity of the platelet is up to approximately 900 S/cm.

24. The dispersible edge functionalised graphene platelet according to claim 20, wherein the platelet is further functionalised by the addition of metal ions to at least one of the functionalised edges or the surface.

25. The dispersible edge functionalised graphene platelet according to claim 24, wherein the metal ions are selected from Fe, Cu, Co, and Sn.

26. A polymer-matrix composite material comprising:
a polymer selected from alginate, chitosan, PVA, PEG, PU, PEI, PVDF, PDMS or PEDOT PSS; and
edge functionalised graphene platelets as defined according to claim 20.

27. (canceled)

28. An electrode for electrochemical processes comprising;
edge functionalised graphene platelets as defined according to claim 20; and
a binder selected from Nafion and PVDF.

29. The method for producing an electrode according to claim 28, the method comprising:
creating a mixture containing edge functionalised graphene platelets as defined according to claim 20 and a binder; and
coating the mixture onto an electrode substrate.

30. A composition for use as a thermal fluid, the composition comprising:
a) an amount of a dispersible graphene platelet as defined according to claim 1 including a base layer of graphene; at least one discontinuous graphene layer stacked on the base layer; wherein the at least one discontinuous layer has a smaller surface area than the base layer; and wherein the edge regions of the base layer and the at least one discontinuous layer are at least partially functionalised; and
b) a dispersion medium comprising an amount of water.
